(19) United States
(12) Patent Application Publication
(10) Pub. No.: US 2004/0077494 A1
(43) Pub. Date: Apr. 22, 2004

(54) Method for depositing particles onto a catalytic support

(76) Inventors: William J. LaBarge, Bay City, MI (US); Conrad Anderson, Davison, MI (US); Joachim Kupe, Davisburg, MI (US)

Correspondence Address: Vincent A. Cichosz, Delphi Technologies, Inc., P.O. Box 5052, M/C 480-410-202, Troy, MI, 48007, US

(21) Appl. No.: 10/277,491

(22) Filed: Oct. 22, 2002

(51) Int. Cl. B01J 23/02

(52) U.S. Cl. 502/303; 502/439

(57) ABSTRACT

Disclosed herein are methods for depositing catalytic material on a support, methods for making a gas treatment device, and the gas treatment devices formed therefrom. In one embodiment, the method for disposing a catalytic material on a support comprises: contacting the support with a catalytic material and a supercritical fluid, changing the supercritical fluid to a non-supercritical fluid, and depositing at least a portion of the catalytic material in pores of the support, wherein the catalytic material has a first solubility in the supercritical fluid of greater than or equal to about 70% and a second solubility in the non-supercritical fluid of less than or equal to about 20%. In one embodiment, the method for making the gas treatment device comprises disposing the supported catalytic material onto a substrate and disposing the substrate in a housing comprising an inlet for receiving gas and an outlet.

### BACKGROUND OF THE INVENTION

Known combustion catalysts are usually prepared from a monolithic substrate of ceramic or metal on which a substrate comprising a fine layer of one or more refractory oxides, usually alumina, is deposited, which has a higher surface area and porosity to that of the monolithic substrate. The catalytic material, composed mainly of precious metals, is dispersed onto this substrate.

In the combustion process, catalysts are subjected to very high temperatures, often greater than 1,000° C. During use of the catalysts at these high temperatures, the catalyst degrades and catalytic performance is thereby reduced. Of the possible causes for this degradation in performance, sintering of the substrate and sintering of the catalytic material and/or encapsulation thereof by the substrate are among those most frequently blamed. Due to the high monetary cost of precious metals comprising the catalytic material, such sintering or encapsulation results in high economic waste. Therefore, the availability of less expensive catalytic materials, and/or a more efficient method for depositing the catalytic material onto the substrate is currently needed.

### SUMMARY OF THE INVENTION

The above-mentioned problems may be resolved by the are methods for depositing catalytic material on a support, methods for making a gas treatment device, and the gas treatment device formed therefrom, disclosed herein. In one embodiment, the method for disposing a catalytic material on a support comprises: contacting the support with a catalytic material and a supercritical fluid, changing the supercritical fluid to a non-supercritical fluid, and depositing at least a portion of the catalytic material in pores of the support, wherein the catalytic material has a first solubility in the supercritical fluid of greater than or equal to about 70% and a second solubility in the non-supercritical fluid of less than or equal to about 20%.

In one embodiment, the method for making the gas treatment device comprises disposing the supported catalytic material onto a substrate and disposing the substrate in a housing comprising an inlet for receiving gas and an outlet. The resulting gas treatment devices comprise reformers, exhaust emission control devices, and the like.

The above described and other features and advantages are exemplified by the following detailed description and appended claims.

### DESCRIPTION OF THE PREFERRED EMBODIMENT

Disclosed herein is a method for depositing a catalytic material onto a substrate, and to an article formed therefrom. The method comprises contacting the substrate with a fluid, wherein the fluid comprises a catalytic material in combination with a supercritical compound. As used herein, “supercritical” refers to the physical phase of a compound where, at the compound's critical temperature (T_{C}), the fluid phase cannot be liquefied by pressures at or below the critical pressure (P_{C}) of that compound.

The fluid may comprise any supercritical compound useful in disposing a catalytic material onto a substrate where the substrate is useful in a gas treatment device. Possible supercritical compounds include carbon dioxide, ammonia, water, ethane, ethene, propane, xenon, nitrous oxide, fluoroform, and the like, and combinations comprising at least one of the foregoing, with water and ammonia preferred, and carbon dioxide most preferred. Carbon dioxide is especially preferred due to its relatively low T_{C} (e.g., about 31° C.), its low economic cost, and its chemical stability, non-flammability, and non-toxicity.

The catalytic material may be entrained in the fluid, such that the catalytic material may be solubilized, dissolved, emulsified, suspended, or dispersed (e.g., physically or chemically) in the fluid during transport of the fluid to the substrate and also upon the interaction of the fluid with the substrate surface. Optionally, a dispersing agent or the like may be employed with the fluid.

The fluid is preferably pressurized at the T_{C} of the supercritical compound, wherein “pressurized” is defined to be a pressure greater than the pressure found at ambient temperature, e.g., greater than or equal to about 2 megapascals (MPa). For the present application, the pressure is typically about 2 MPa pressure to about 300 MPa. Within this range, a pressure of less than or equal to about 100 MPa is preferred, with less than or equal to about 40 MPa more preferred. Also preferred is a pressure of greater than or equal to about 5 MPa. For example, carbon dioxide at about 8 MPa and about 35° C. is sufficient to uniformly deposit precious metals into the finest porosity of catalyst supports. The upper limit on the pressure is currently based upon the equipment capabilities with pressures below that which will adversely effect the support possible. Carbon dioxide pressures of up to and exceeding about 40 MPa and up to about 70° C. can be employed. For example, carbon dioxide at a pressure of about 14.7 MPa and 40° C. has been used, although pressure of less than or equal to about 8 MPa are preferred. For example, where carbon dioxide is employed as the supercritical compound, the fluid may be pressurized to about 5 MPa to about 8 MPa at a temperature of about 30° C., e.g., about 7.3 MPa pressure at a temperature of about 31° C.; where ammonia is employed as the supercritical compound, the fluid may be pressurized to about 9 MPa to about 13 MPa at a temperature of about 135° C., e.g., about 11.3 MPa pressure at a temperature of about 133° C.; and where water is employed as a supercritical fluid, the fluid may be pressurized to about 20 MPa to about 23 MPa at a temperature of about 375° C., e.g., about 21.7 MPa pressure at a temperature of about 374° C.

The catalytic material may comprise metals, such as platinum, palladium, rhodium, iridium, ruthenium, gold, silver, and the like, as well as oxides, alloys, and combinations comprising at least one of the foregoing, and other catalytic materials. Preferably, the catalytic material comprises platinum, palladium, rhodium, and ruthenium, and oxides, alloys, and combinations comprising at least one of the foregoing. The catalytic material is preferably chosen based upon its catalytic activity for the desired application and for its solubility. Preferably the catalytic material has a solubility of less than or equal to about 20 weight percent (wt %) in the fluid prior to supercritical state, and greater than or equal to about 70 wt % solubility when in the supercritical state, with a solubility of greater than or equal to about 90 wt % when in the supercritical state preferred.

The catalytic material entrained in the fluid can be disposed onto a catalyst support wherein the catalyst support may comprise any material designed for use in a gas treatment device and that has the following characteristics: (1) capable of operating at temperatures up to about 600° C., and up to and exceeding about 1,000° C. for some applications, depending upon the device's location within the exhaust system (manifold mounted, close coupled, or underfloor) and the type of system (e.g., gasoline or diesel); (2) capable of withstanding exposure to hydrocarbons, nitrogen oxides, carbon monoxide, carbon dioxide, and/or sulfur; and (3) having sufficient surface area and structural integrity to support the desired catalyst. Some possible catalyst supports include ceramics such as metal oxides, metal phosphates, metal aluminides, metal carbides, metal silicides, metal nitrides, metal borides, and the like (e.g., aluminum oxide, aluminum phosphate, strontium aluminide, zirconium carbide, and the like) in the form of powders, aggregates, beads, monoliths, foils, sponges, perform, mat, fibrous material, porous glasses, foams, pellets, particles, molecular sieves, and the like (depending upon the particular device), and mixtures comprising at least one of the foregoing materials and forms, wherein powders held together by ceramic binders are particularly preferred, especially aluminates or phosphates.

The catalyst supports can be disposed on a substrate. Some possible substrates to contain the catalyst supports include foils, monoliths, sponges, perform, mat, fibrous material, porous glasses, foams, pellets, particles, molecular sieves, and the like (depending upon the particular device), and mixtures comprising at least one of the foregoing materials and forms, wherein metal foils are particularly preferred, especially stainless steel metal foils. Possible support materials include ceramic (e.g., cordierite, alumina, and the like), metallic, cermet, and carbides (e.g., silicon carbide, and the like), silicides, nitrides (e.g., silicon nitride, and the like), as well as combination and the like, and mixtures comprising at least one of the foregoing materials.

Although the substrate can have any size or geometry, the size and geometry are preferably chosen to optimize the surface area in the given device design parameters. Typically, a catalyst substrate has a honeycomb geometry; with the combs being any multi-sided or rounded shape, with substantially square, hexagonal, octagonal or similar geometries preferred due to the ease of manufacturing and increased surface area. A particulate filter may comprise a fibrous perform or the like.

The catalyst support preferably has a surface area sufficient to uphold a sufficient amount of catalytic material to effectively catalyze and/or adsorb compounds in exhaust gas streams flowing therethrough, with the surface area being a function of the surface design of the element, the volume of the element, and the effective density of the element. These parameters may be adjusted according to the design needs, taking into account both the desired shape of the exhaust emissions control device and optimal paths for exhaust gas flow.

The catalyst support which can adsorb hydrocarbons, steam, and other combustion exhaust stream components, can include zeolites, such as Beta, fujisites such as Y, FERIERITE (also known as FER), MFI (also known as “ZSM-5”), and “LZ-210” which is commercially available from UOP, Inc.; and/or a large pore zeolite such as zeolite Y, rare-earth-exchanged zeolite Y, ultra stable zeolite Y, de-aluminated zeolite Y, zeolite L, zeolite beta, ZSM-3, ZSM-4, ZSM-18, ZSM-20; a medium pore zeolite such as ZSM-12, ZSM-23, ZSM-35, ZSM-38, ZSM48, zeolite MCM-22, 13X zeolite powder commercially available from PQ Corporation, Beryn, Pa., CBV-100 zeolite powder commercially available from Zeolyst International, or other similar material, as well as inorganic oxides such as aluminum oxide (e.g., SCFa 140 L3 lanthanum stabilized gamma-alumina commercially available from Condea Vista, Houston, Tex.); and the like; and mixtures comprising at least one of the foregoing materials, and other adsorption materials. Some possible other support materials include oxides (e.g., aluminum oxides, lanthanum oxides, neodymium oxides, barium oxides, strontium oxides, zirconium oxides, cerium-zirconium solid solutions, titanium oxides, zeolites, and the like), aluminides, aluminates, hexaaluminates (including crystal stabilized hexaaluminates), alluminogallates, zirconates, cerates, and the like. Also included are combinations comprising at least one of any of the foregoing supports.

In preparation of the catalyst supported on a substrate, the substrate may be coated prior to introduction of the catalyst. Where coating is not applied as a component of the supercritical fluid, the coating may be applied onto the substrate by various techniques, including wash coating, impregnating, imbibing, physisorbing, chemisorbing, precipitating, dipping, spraying, painting, and the like, wherein wash-coating is preferred. After applying the coating onto the substrate, the coating may be annealed and oxidized by, for example, calcining at about 1,100° C. for up to and exceeding about 4 hours.

The catalytic material, on the other hand, is disposed onto the catalyst support by way of the supercritical fluid. Deposition begins by positioning the catalyst support in an appropriate pressurized system (e.g., vessel) such as, for example, a batchwise or semi-continuous system. The catalytic material may be added to the vessel before, after, or simultaneously with the supercritical fluid. After introduction of the supercritical fluid, the vessel is pressurized to the appropriate pressure for the fluid chosen and then the pressurized fluid is heated to the supercritical compound's T_{C} (e.g., about 7.3 MPa at 31° C. for carbon dioxide; 11.3 MPa at 133° C. for ammonia; and 21.7 MPa at 374° C. for water). Once the support has been impregnated with the supercritical fluid and the catalyst material, the process is reversed. For example, the vessel is no longer heated (i.e., it is actively or passively cooled) such that the supercritical fluid cools, and the pressure is decreased (either simultaneously or sequentially).

The supported catalytic material can then be deposited onto/in the substrate. The supported catalytic material may be wash coated, imbibed, impregnated, physisorbed, chemisorbed, precipitated, sprayed, dipped, or otherwise applied to the substrate.

Care should be taken to insure that the catalytic material is in fact deposited onto the catalyst support. In general, four different techniques for depositing the catalytic material onto the catalyst support can be employed. In each, the catalytic material is preferably entrained in the fluid as a stable solution. Most preferably, the formulation of fluid and catalytic material is homogeneous (e.g., optically clear) at initiation of the contacting step.

In one embodiment, the catalytic material may be entrained in the fluid at an appropriate temperature and pressure, followed by contacting the catalyst support with the fluid and lowering the fluid pressure. This effects a lowering of the fluid density below a critical level, thus vaporizing the fluid and depositing the catalytic material into the porosity of catalyst support. The system pressure may be lowered by any suitable means depending upon the particular equipment employed.

In another embodiment, carbon dioxide is added as a gas. The catalytic materials have limited solubility in the initial gas state. The gas is pressurized to a liquid. The catalytic materials have some solubility in the liquid. The liquid is heated to the supercritical point (e.g., the temperature above which no amount of pressure can liquefy the gas). The catalytic materials have excellent solubility in the supercritical gas. The supercritical gas forces the catalytic materials uniformly throughout the catalyst support. The pressure can be lowered, preferably rapidly (e.g., at a rate of greater than or equal to about 0.1 MPa/second), to below the supercritical pressure. The solubility of the active metal greatly decreases and superfine nuclei (i.e., the active materials have all atoms exposed; the size is so small that essentially the entire area is considered active (e.g., a size of about 10 Å)) of the active metals are left in the porosity of the catalyst support. The metal catalyzed support is removed from the system. The metal catalyzed support is calcined up to about 1,100° C. or so, depending upon the support used.

For example, about 100 kilograms (kg) catalyst powder and a solid precious metal compound containing 0.75 kg precious metal can be loaded into the reactor chamber. Liquid carbon dioxide, possibly including a surfactant, can then be pumped into the chamber. The pressure of the chamber can then be raised to above 7.3 MPa. Then, the chamber temperature and materials within it can be heated to at least 32° C., forming supercritical fluids comprising carbon dioxide and solvated precious metal compounds. The catalyst support can be agitated in the presence of the supercritical fluid. The process is then reversed; the temperature is decreased or allowed to decrease, reducing the solubility of the precious metal compounds. The pressure is then reduced to below 7.3 MPa, e.g., by venting the carbon dioxide through a chiller and storing the liquid to be reused again. The virtually dry catalyst powder (i.e., the catalyst support with the catalyst material disposed on and through the support) is calcined.

In another embodiment, carbon dioxide is added as a gas, pressurized to a liquid and heated to the supercritical point. The temperature is then lowered below the supercritical temperature while leaving the pressure constant. The supercritical gas changes phase to liquid and the solubility of the catalytic materials decreases. The liquid can be removed from the reactor vessel. Due to the lowered solubility, some of the catalytic materials are left in the porosity of the catalyst support. The metal catalyzed support is removed from the system. The metal catalyzed support is calcined up to about 1,100° C. or so, depending upon the support used.

In yet another embodiment, catalytic material may be deposited onto the catalyst support by contacting the catalyst support with the catalytic material entrained in the fluid. The fluid is then diluted to a point that destabilizes the catalytic material in the fluid resulting in deposition of the catalytic material onto the substrate catalyst support. For example the catalytic materials may have high solubility in ammonia, lower solubility in carbon dioxide and much lower solubility in water. The catalytic materials may be initially dissolved and distributed through the catalyst support in a pure ammonia supercritical fluid. Then a second supercritical fluid may be added to reactor. For example 10 parts ammonia diluted to about 6 parts ammonia and 4 parts carbon dioxide. The pressure is released and the fluids are removed leaving the catalytic materials deposited in the porosity of the catalyst support.

In another embodiment, the catalyst support is contacted with the catalytic material entrained in the fluid at sub-ambient temperature (e.g., below about 23° C.) and at a given pressure (e.g., at standard pressure about 0.1 MPa), followed by increasing the temperature of the fluid to a point at which the catalytic material destabilizes in the fluid and the catalytic material is deposited onto the catalyst support. For example catalytic materials are dissolved into water and the mixture added to a reactor containing a catalyst support. The catalytic materials, catalyst support, and fluid are heated to at least about 375° C. and pressurized to at least about 22 MPa. The supercritical steam that is generated deposits the catalytic materials uniformly upon the catalyst support including the fine porosity. After about 20 minutes the temperature and pressure can be reduced to ambient (e.g., about 23° C. and about 0.1 MPa). The catalyst material has deposited upon the high surface area support. The catalyst support with catalytic metals is removed from the reactor and calcined.

In a yet another embodiment, the catalytic material is entrained in the fluid at a sub-ambient temperature (e.g., below about 23° C.) in a high-pressure vessel. A second vessel contains the catalyst support and a fluid at a temperature sufficiently higher than a solvent/catalytic material to destabilize the metered fluid and cause the deposition of the catalytic material onto the catalyst support. For example a first reactor contains catalytic materials such as rhodium 2-ethylhexanoate in an organic fluid such as toluene (i.e., the solvent). A second reactor contains a catalyst support such as barium hexaaluminate and a fluid such as liquid carbon dioxide at supercritical conditions (e.g., 7.3 MPa and 31° C.). The supercritical fluid and catalytic support are injected into the first reactor containing the catalytic material and solvent. The catalytic material and solvent are vaporized and react with the incoming supercritical liquid and catalyst support. The significant decrease in solubility of catalytic material in the diluted solvent causes deposition of catalytic materials onto the incoming catalytic support. The support with the catalytic materials disposed thereon and through, is then removed from the reactor and calcined.

A commercially made reactor can be purchased for about $125,000. A reactor could catalyze 100 kg of powder in 20 minutes. In a sixteen-hour period perhaps 30 batches could be made. Thirty batches could make enough material for about 15,000 catalytic converters. One reactor could make enough powder for 3,000,000 converters. The precious metals on a typical converter cost about $50. A reduction of 20% or more may be possible with use of the entire support oxide surface. One reactor making powder that allows a twenty percent reduction in precious metals would save for 3,000,000 converters about $30,000,000.

Supercritical fluids can be employed to disposed catalyst materials on many different supports for variety of applications. The use of the supercritical fluid is highly effective and efficient. It is noted that more catalytic material may be entrained in the supercritical fluid than is deposited on/in the support; merely deposition of a sufficient quantity to achieve the desired loading is desired. It is believed that, due to the effective deposition of the catalytic materials throughout the support, the catalyst loading (particularly the precious metal loading) can be reduced by about 20% while retaining the catalyst reactivity; e.g., the loading can be reduced from a loading of about 10 grams per cubic foot (g/ft³) to about 140 g/ft³, down to a loading of less than or equal to about 55 g/ft³, and even down to a loading of about 35 g/ft³ to about 45 g/ft³. This will result in a major cost savings.

In automotive applications, for example, supercritical fluid may be used to deposit precious metals (and other catalysts) on/in supports used for fuel treatment devices (e.g., a reformer), and/or various exhaust emission control devices (catalytic converters, evaporative emissions devices, scrubbing devices (e.g., hydrocarbon, sulfur, and the like), particulate filters/traps, adsorbers/absorbers, non-thermal plasma reactors, and the like). For example, close coupled or manifold mounted catalysts can comprise greater than or equal to about 90 wt % aluminum oxide (based upon the total weight of the support) having a surface area of greater than or equal to about 80 meters squared per gram (m/g²) after 24 hours at 1,150° C. (preferably calcined for the 24 hours at about 1,150° C. before the precious metal doping), and preferably comprising greater than or equal to about 90% of its pores having a size of about 10 Angstroms (Å) to about 40 Å. More particularly, for example, the alumina oxide could be stabilized gamma aluminum oxide containing about 3 wt % barium or lanthanum (based upon the total weight of the aluminum oxide) incorporated into the crystalline structure. The catalytic material can preferably be palladium and rhodium deposited in an amount of about 0.10 wt % to about 3.12 wt %, with about 0.48 wt % to 11.1 wt % preferred, based upon the total combined weight of the catalytic materials and the catalyst support.

In anther embodiment, the supercritical fluids may be employed used to deposit catalytic material (e.g., precious metal compounds) on/in a support (e.g., aluminum oxide, cerium oxide, and/or zirconium oxide (separately or combined)), e.g., for use as hydrocarbon and carbon monoxide active portions of three way catalysts. In other words, the catalytic materials can be disposed on the supports individually or a mixture of the supports with simultaneous deposition. With separate deposition, the supported catalysts (which can be the same or different catalytic materials) can be disposed as layers, as desired, for example, where each layer may have different amounts of aluminum oxide, cerium oxide and zirconium oxide.

In another automotive application, the supercritical fluids may be used to deposit catalytic materials (e.g., precious metal compounds) on/in a support, e.g., cerium zirconium NOx active portions of three way catalysts comprising solid solutions of cerium zirconium oxide, with or without stabilizing oxides lanthanum and yttrium, and with or without NOx storage components such as barium, strontium, calcium and potassium. Preferably the catalytic material deposited on/in the cerium zirconium oxide is palladium and possibly other precious metals deposited in an amount of about 0.10 wt % to about 3.12 wt %, with about 0.48 wt % to 1.1 wt % preferred, based upon the total combined weight of the catalytic materials and the catalyst support.

### EXAMPLE 1

A stainless steel reactor was equipped with heating and cooling coils. Liquid carbon dioxide was stored in a separate vessel at about 2.0 MPa and −18° C. One hundred grams of Condea Vista PURALOX SCFa-140 L3 (i.e., aluminum oxide stabilized with 3 wt % lanthanum) and 1.375 grams palladium (II) acetylacetonate were placed into the stainless steel reactor chamber. A total of 0.48 grams palladium (Pd) was contained in the palladium (II) acetylacetonate. Gaseous carbon dioxide was pumped into the 25° C. reactor chamber until the pressure increased to about 6.3 MPa. The fluid in the reactor chamber was heated to about 40° C. (Although this equipment did not allow agitation of the powder, it is envision that during a commercial process the powder would be agitated.) Forty minutes after the temperature was raised to 40° C., the chamber was cooled to 21° C. At 21° C. the gaseous carbon dioxide was vented from the reactor chamber and condensed to a liquid for reuse. The powder was removed from the reactor and calcined in a furnace to 1,140° C.

A slurry was made consisting of 100 grams Pd doped lanthanum aluminum oxide, 15.40 grams zirconium citrate, 15.58 grams strontium citrate, 9.18 grams aluminum hydroxide sol at 25 wt % solids, and 100 grams water. The calcined coating contained about 87 wt % lanthanum stabilized aluminum oxide, about 9 wt % strontium zirconate, and about 4 wt % strontium aluminate as a binder. The mixture was ball milled for 2 hours and washcoated on a 600 cells per cubic inch cordierite monolith at a loading of about 2.2 grams per cubic inch. The washcoated monolith was calcined for four hours at about 500° C.

### EXAMPLE 2

Similar to EXAMPLE 1 except that with rhodium is included in the catalyst. One hundred grams of Condea Vista PURALOX SCFa-140 L3, 1.38 grams palladium (II) acetylacetonate, and 0.27 grams rhodium (III) acetylacetonate were placed into the stainless steel reactor chamber. A total of 0.48 grams palladium was contained in the palladium (II) acetylacetonate and a total of 0.12 grams rhodium (Rh) was contained in the rhodium (III) acetylacetonate. Gaseous carbon dioxide was pumped into the 25° C. reactor chamber until the pressure increased to about 6.3 MPa. The fluid in the reactor chamber temperature was heated to about 40° C. (Although this equipment did not allow agitation of the powder, it is envision that during a commercial process the powder would be agitated.) Forty minutes after the temperature was raised to 40° C., the chamber was cooled to 21° C. At 21° C. the gaseous carbon dioxide was vented from the reactor chamber and condensed to a liquid for reuse. The powder was removed from the reactor and calcined in a furnace to 1,140° C.

A slurry was made consisting of 100 grams Pd-Rh doped lanthanum aluminum oxide, 15.40 grams zirconium citrate, 15.58 grams strontium citrate, 9.18 grams aluminum hydroxide sol at 25 wt % solids, and 100 grams water. The calcined coating contained about 87 wt % lanthanum stabilized aluminum oxide, about 9 wt % strontium zirconate, and about 4 wt % strontium aluminate as a binder. The mixture was ball milled 2 hours and washcoated on a 600 cells per cubic inch cordierite monolith at a loading of about 2.2 grams per cubic inch. The washcoated monolith was calcined for four hours at about 500° C.

### EXAMPLE 3A

### Material for Deposition of the First Layer.

Nineteen point one six grams of lanthanum acetate, 23.77 grams of yttrium acetate, 121.86 grams cerium acetate, and 53.00 grams zirconium acetate were mixed together with 500 grams distilled water. The acetate solution was loaded into an autoclave and heated to 2.0 MPa at 225° C. for 1 hour. The solution was vented allowing the water to be removed. The mixed acetate solutions were well mixed then calcined at 325° C. for 2 hours. The calcined powder was ball milled 2 hours and then calcined to 925° C. for 4 hours. The calcined compound was La_{0.06}Ce_{0.58}Y_{0.02}Zr_{0.29}O_{1.28}.

A mixture of about 54 grams SCFa-140 L3, and 46 grams La_{0 06}Ce_{0 58}Y_{0 02}Zr_{0 29}O_{1.28} were added to a reactor. The calcined mixture was mixed with 3.24 grams palladium (II) acetate and was placed into a stainless steel reactor chamber. A total of 1.20 grams palladium was contained in the palladium (II) acetate. Gaseous carbon dioxide was pumped into the 25° C. reactor chamber until the pressure increased to about 6.3 MPa. The fluid in the reactor chamber temperature was then heated to about 40° C. Forty minutes after the temperature was raised to 40° C., the chamber was cooled to 21° C. At 21° C. the gaseous carbon dioxide was vented from the reactor chamber and condensed to a liquid for reuse. The powder was removed from the reactor and calcined in a furnace to 925° C. A slurry was made consisting of 80 grams of Pd doped SCFa-140 L3-La_{0.06}Ce_{0 58}Y_{0 02}Zr_{0 29}O_{1.28}, 18.6 grams zirconium acetate, 27.45 grams strontium acetate, 11.16 grams barium acetate, and 9.18 grams aluminum hydroxide sol at 25 wt % solids, and 100 grams water. The calcined coating contained about 84 wt % of the Pd doped SCFa-140 L3/La_{0 06}Ce_{0.58}Y_{0.02}Zr_{0 29}O_{1 28}, about 8 wt % strontium zirconate, and 8 wt % barium aluminate as binders. The mixture was ball milled 2 hours and washcoated on a 600 cells per cubic inch cordierite monolith at a loading of about 1.1 grams per cubic inch. The washcoated monolith was calcined for four hours at about 500° C.

### EXAMPLE 3B

### Material for Deposition of the Second Layer.

Nineteen point one six grams of lanthanum acetate, 23.77 grams of yttrium acetate, 121.86 cerium acetate, and 53.00 grams zirconium acetate are mixed together with 500 grams distilled water. The acetate solution was loaded into an autoclave and heated to 2.0 MPa at 225° C. for 1 hour. The solution was vented allowing the water to be removed. The mixed acetate solutions were well mixed then calcined at 325° C. for 2 hours. The calcined powder was ball milled 2 hours then calcined to 925° C. for 4 hours. The calcined compound was La_{0 03}Ce_{0.29}Y_{0.04}Zr_{0 58}O_{1 89}.

A mixture of about 54 grams SCFa-140 L3 and 46 grams La_{0 03}Ce_{0.29}Y_{0 04} Zr_{0.58}O_{1.89} were added to a reactor. The calcined mixture was mixed with 2.22 grams rhodium (III) acetylacetonate and 2.22 grams platinum (II) acetylacetonate and was placed into a stainless steel reactor chamber. A total of 0.40 grams rhodium and 0.40 grams platinum were contained in the acetylacetonates. Gaseous carbon dioxide was pumped into the 25° C. reactor chamber until the pressure increased to about 6.3 MPa. The fluid in the reactor chamber temperature was then heated to about 40° C. Forty minutes after the temperature was raised to 40° C., the chamber was cooled to 21° C. At 21° C. the gaseous carbon dioxide was vented from the reactor chamber and condensed to a liquid for reuse. The powder was removed from the reactor and calcined in a furnace to 925° C.

A slurry was made consisting of 94.0 grams rhodium and platinum doped SCFa-140 L3La_{0.03}Ce_{0 29}Y_{0.04}Zr_{0.58}O_{1 89}, 18.24 grams zirconium acetate, 15.58 grams strontium acetate, and 9.18 grams aluminum hydroxide sol at 25 wt % solids, and 100 grams water. The calcined coating contained about 94 wt % of the Pd doped SCFa-140 L3/La_{0 03}Ce_{0.29}Y_{0 04}Zr_{0.58}O_{1 89}, about 3 wt % strontium zirconate, and 3 wt % barium aluminate as binders. The mixture was ball milled 2 hours and washcoated on a 600 cells per cubic inch cordierite monolith at a loading of about 2.2 grams per cubic inch. The washcoated monolith was calcined for four hours at about 500° C.

### EXAMPLE 4

### Formation of the Support Oxide.

One hundred and twelve grams of zirconium acetate at about 15 wt % zirconium, 61.4 grams of titanium dioxide from colloidal titanium dioxide, and 60.8 grams yttrium acetate were mixed together with 500 grams ethanol. The solution was loaded into a stainless steel reactor chamber pressurized to about 7.3 MPa and heated to about 260° C. After about 20 minutes the supercritical ethanol was extracted from the chamber by slowly opening a release valve and allowing the hot ethanol to escape. After the pressure was brought to ambient the chamber was allowed to cool slowly to room temperature. The support oxide was removed from the reactor and calcined 2 hours at 800° C. A high surface area titanium dioxide support with yttrium stabilized zirconium dioxide deposited in the pores was thus formed. The support was about 82 mole percent (mol %) titanium dioxide and 18 mole percent yttrium stabilized zirconium dioxide. It is believed that the yttrium stabilized zirconium dioxide deposited in the titanium dioxide pores inhibits the high surface area titanium dioxide structure from collapsing.

### EXAMPLE 4B

### Deposition of the catalytic material.

One point zero grams of rhodium (III) acetate at 10.0 wt % rhodium and 10.0 grams tetraammine platinum (II) hydroxide solution at 10.0 wt % platinum was mixed in 500 grams ethanol. The support material was mixed with the catalytic material and ethanol solution. The mixture was loaded into the stainless steel reactor chamber. The catalytic materials, catalyst support and fluids were heated to at least 260° C. After about 20 minutes, the supercritical ethanol was extracted from the chamber by slowly opening a release valve and allowing the hot ethanol to escape. After the pressure was brought to ambient pressure, the chamber was allowed to cool slowly to room temperature. The support oxide with deposited catalytic material was removed from the reactor and calcined 2 hours at 500° C.

A slurry was made consisting of 94.0 grams rhodium and platinum doped yttrium-zirconium oxide impregnated titanium dioxide, 18.24 grams zirconium acetate, 15.58 grams strontium acetate, 9.18 grams aluminum hydroxide sol at 25 wt % solids, and 100 grams water. The mixture was ball milled 2 hours and washcoated on a 600 cells per cubic inch cordierite monolith at a loading of about 2.2 grams per cubic inch. The washcoated monolith was calcined for 4 hours at about 500° C. The calcined washcoat contained about 92 wt % of the platinum-rhodium doped yttrium-zirconium oxide impregnated titanium dioxide and about 4 wt % strontium zirconate and 4 wt % strontium aluminate as binders.

Once the catalytic material has been disposed on and/or throughout the catalyst support, the catalyst support can then be employed in a gas treatment device, typically supported on a substrate. The gas treatment device may comprise catalytic converters, evaporative emissions devices, scrubbing devices (e.g., hydrocarbon, sulfur, and the like), particulate traps, adsorbers/absorbers, non-thermal plasma reactors, and the like. The gas treatment device can comprise a housing, or shell, with the substrate concentrically disposed therein, and a retention material disposed between the substrate and housing. Additionally, the supported catalytic material can be employed in various catalytic reactors.

The retention material insulates the shell from both the high exhaust gas temperatures and the exothermic catalytic reaction occurring within the catalyst substrate. The retention material, which enhances the structural integrity of the substrate by applying compressive radial forces about it, reducing its axial movement and retaining it in place, is typically concentrically disposed around the substrate to form a retention material/substrate subassembly.

The retention material, which can be in the form of a mat, particulates, or the like, can either be an intumescent material (e.g., a material that comprises vermiculite component, i.e., a component that expands upon the application of heat), a non-intumescent material, or a combination thereof. These materials can comprise ceramic materials and other materials such as organic binders and the like, or combinations comprising at least one of the foregoing materials. Non-intumescent materials include materials such as those sold under the trademarks “NEXTEL” and “SAFFIL” by the “3M” Company, Minneapolis, Minn., or those sold under the trademark, “FIBERFRAX” and “CC-MAX” by the Unifrax Co., Niagara Falls, N.Y., and the like. Intumescent materials include materials sold under the trademark “INTERAM” by the “3M” Company, Minneapolis, Minn., as well as those intumescents which are also sold under the aforementioned “FIBERFRAX” trademark, as well as combinations thereof and others.

The choice of material for the shell depends upon the type of exhaust gas, the maximum temperature reached by the substrate, the maximum temperature of the exhaust gas stream, and the like. Suitable materials for the shell can comprise any material that is capable of resisting under-car salt, temperature, and corrosion. Typically, ferrous materials are employed such as ferritic stainless steels. Ferritic stainless steels can include stainless steels such as, e.g., the 400-Series such as SS-409, SS-439, and SS-441, with grade SS-409 generally preferred.

Also similar materials as the shell, e.g., end cone(s), end plate(s), exhaust manifold cover(s), and the like, can be concentrically fitted about the one or both ends and secured to the housing to provide a gas tight seal. These components can be formed separately (e.g., molded or the like), or can be formed integrally with the housing using methods such as, e.g., a spin forming, or the like.

There are several advantages to the method and resulting supported catalytic material disclosed herein. Existing gas phase precious metal compounds are deposited by line of sight in a vacuum atmosphere (chemical vapor deposition (CVD)). The precious metal, however, deposits only on the surface never in the pores. Similarly, solid or liquid precious metals are diluted with a liquid. The catalyst support (aluminum oxide, etc.) is then mixed with the liquid. The liquid on the catalyst support is dried and calcined. These solutions typically have surface tension above that necessary to penetrate into the pores unless those pores are very large. Again, the precious metal solutions do not penetrate the fine pores, in this case, due to the high surface tension. Likewise, a catalyst support sprayed with precious metal-liquid solution, needs to be dried and calcined. During drying, the precious metals migrate with the solvent out of the pores As a result, the solvent evaporating from the support surface leaves concentrated precious metal regions. Upon calcination the resulting product comprises large precious metal particles primarily on the surface of the support. Consequently, the benefit of purchasing supports with high surface area is lost. To address the problem, at least in the case of the liquid, a pressurized container can be used to force the precious metal-liquid into the pores. However the precious metal-support still has to be dried. During drying, the precious metal migrates with the liquid out of the pores. The calcined result is still precious metals on the surface of a support and not in the pores.

In contrast to the above methods, the process disclosed herein disperses the catalyst throughout the support, including within the fine pores (e.g., a pore size of less than or equal to about 16 Å). For example, catalytic materials (e.g., precious metal materials) that are not very soluble in the fluid when it is not in the supercritical form. Upon heating and pressurizing the fluid to a supercritical state, however, the solubility greatly increases (e.g., from about 10% to about 95%). The fluid in the supercritical state transports the catalytic materials even into the finest pores of the support. When the supercritical state is released, the catalytic material solubility again greatly decreases causing the materials to be deposited along the supports internal porosity (e.g., as superfine nuclei). Additionally, migration of the catalytic materials out of the fine pores during drying and calcination is greatly reduced or eliminated because of the reduced solubility and therefore the ability of the fluid to draw the materials to the surface of the support. Consequently, depositing the catalytic material by way of a supercritical compound, leads to better dispersion of the catalytic material onto the substrate

Another advantage is that supports having different pore sizes than possible to previously employ may be effectively employed (e.g., aluminum oxides, or other supports, may have pore sizes of about 100 Å to about 500 Å, or about 50 Å to about 200 Å, and even about 10 Å to about 40 Å.

With respect to efficiency, typically about 70% or more of the precious metals are deposited within 5 nanometers of the surface, with a precious metal particle size distribution, along the major axis of the particle, of about 7 to about 12 nanometers (nm) as determined by TEM (transmission electron microscopy). In contrast, if the support is a stable material, e.g., hexaaluminates (particularly crystal stabilized hexaaluminates), the supercritical deposition provides a uniform precious metal distribution over/in the support and decreases the average catalytic material particle size, along the major axis of the particle, to about 2 to about 4 nanometers (as determined by TEM), a greater than or equal to about 30% reduction in the catalytic material loading is readily attainable, with an about 50% to about 80% decrease in the catalytic material (e.g., precious metal) loading possible, while retaining activity. This is partially because subsurface catalytic materials (e.g., precious metals) are much less likely to be poisoned (e.g., in a vehicle, from valve train deposits) and there are many more exposed precious metal atoms available for catalysis.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for disposing a catalytic material on a support, comprising:
contacting the support with a catalytic material and a supercritical fluid;
changing the supercritical fluid to a non-supercritical fluid; and
depositing at least a portion of the catalytic material in pores of the support;
wherein the catalytic material has a first solubility in the supercritical fluid of greater than or equal to about 70% and a second solubility in the non-supercritical fluid of less than or equal to about 20%.

2. The method of claim 1, wherein the catalytic material is selected from the group consisting of platinum, palladium, rhodium, iridium, ruthenium, gold, silver, and oxides, alloys, and combinations comprising at least one of the foregoing catalytic materials.

3. The method of claim 2, wherein the catalytic material is selected from the group consisting of platinum, palladium, rhodium, ruthenium, and oxides, alloys, and combinations comprising at least one of the foregoing catalytic materials.

4. The method of claim 2, wherein the supercritical compound is selected from the group consisting of carbon dioxide, ammonia, water, ethane, ethene, ethanol, propane, xenon, nitrous oxide, fluoroform, and combinations comprising at least one of the foregoing.

5. The method of claim 4, wherein the supercritical compound is selected from the group consisting of carbon dioxide, ammonia, ethanol, water, and combinations comprising at least one of the foregoing.

6. The method of claim 1, further comprising lowering a pressure of the pressurized fluid.

7. The method of claim 1, wherein changing the supercritical fluid to a non-supercritical fluid further comprises diluting the supercritical fluid.

8. The method of claim 1, wherein changing the supercritical fluid to a non-supercritical fluid further comprises changing the temperature of the supercritical fluid.

9. The method of claim 1, wherein changing the supercritical fluid to a non-supercritical fluid further comprises changing the pressure of the supercritical fluid.

10. The method of claim 1, further comprising raising a fluid's temperature to a critical temperature and increasing a pressure at the critical temperature to form the supercritical fluid.

11. The method of claim 10, wherein the pressure is increased to greater than or equal to about 2 MPa.

12. The method of claim 11, wherein the pressure is increased to about 2 MPa to about 100 MPa.

13. The method of claim 12, wherein the pressure is increased to about 5 MPa to about 40 MPa.

14. The method of claim 1, wherein contacting the support further comprises introducing a fluid to a reaction chamber comprising the catalytic material and the support, increasing at least one of a temperature and a pressure of the fluid to attain the supercritical fluid.

15. The method of claim 14, wherein contacting the support further comprises introducing a fluid to a reaction chamber comprising the catalytic material and the support until the fluid attains a desired pressure, and then increasing a temperature of the fluid to attain the supercritical fluid.

16. The method of claim 15, further comprising agitating the catalytic material and support.

17. The method of claim 1, wherein the support is selected from the group consisting of aluminum oxides, lanthanum oxides, neodymium oxides, barium oxides, strontium oxides, zirconium oxides, cerium-zirconium solid solutions, titanium oxides, zeolites, aluminides, aluminates, hexaaluminates, alluminogallates, zirconates, cerates, and combinations comprising at least one of the foregoing supports.

18. The method of claim 17, wherein the support is selected from the group consisting of aluminum oxides, zeolites, aluminides, hexaaluminates, and combinations comprising at least one of the foregoing supports.

19. The method of claim 1, wherein the support comprises a crystal stabilized hexaaluminate.

20. A method for making a gas treatment device, comprising:
contacting a support with a catalytic material and a supercritical fluid;
changing the supercritical fluid to a non-supercritical fluid; and
depositing at least a portion of the catalytic material in pores of the support to form a supported catalytic material, wherein the catalytic material has a first solubility in the supercritical fluid of greater than or equal to about 70% and a second solubility in the non-supercritical fluid of less than or equal to about 20%;
disposing the supported catalytic material onto a substrate; and
disposing the substrate in a housing comprising an inlet for receiving gas and an outlet.

21. The method of claim 20, wherein the substrate comprises a metal foil.

22. The method of claim 21, wherein the metal foil comprises stainless steel.

23. The method of claim 20, wherein contacting the support further comprises introducing a fluid to a reaction chamber comprising the catalytic material and the support until the fluid attains a desired pressure, and then increasing a temperature of the fluid to attain the supercritical fluid.

24. The method of claim 20, wherein the supercritical fluid is selected from the group consisting of carbon dioxide, water, ammonia, ethanol, and combinations comprising at least one of the foregoing supercritical fluids.

25. The method of claim 20, wherein the support is selected from the group consisting of aluminum oxides, zeolites, aluminides, hexaaluminates, and combinations comprising at least one of the foregoing supports.

26. The method of claim 20, wherein the support comprises a crystal stabilized hexaaluminate.

27. The method of claim 20, further comprising disposing a retention material between the substrate and the housing.

28. The gas treatment device of claim 20, wherein the device is a reformer.

29. The gas treatment device of claim 20, wherein the device is an exhaust emission control device.
